(19) United States
(12) Patent Application Publication
(10) Pub. No.: US 2009/0152139 A1
(43) Pub. Date: Jun. 18, 2009

(54) PACKAGING SACHET AND METHOD AND DEVICE FOR PRODUCING THE SAME

(75) Inventors: Hermann Roesink, ED Abcoude (NL); Claus Ehrhardt, Hamburg (DE)

Correspondence Address: SUGHRUE MION, PLLC, 2100 PENNSYLVANIA AVENUE, N.W., SUITE 800, WASHINGTON, DC, 20037, US

(73) Assignee: FOCKE & CO., (GmbH & CO., KG), VERDEN (DE)

(21) Appl. No.: 11/719,668

(22) PCT Filed: Oct. 28, 2005
(86) PCT No.: PCT/EP2005/011538

§ 371 Date: May 18, 2007

(30) Foreign Application Priority Data
Nov. 19, 2004 (DE) 10 2004 056 043.9

(51) Int. Cl. B65D 85/00; B65D 33/16; B31B 1/00; B31B 1/74

(52) U.S. Cl. 206/260; 383/64; 493/267; 493/213

(57) ABSTRACT

A pouch (10) for holding in particular a portion of tobacco substantially comprises front wall (13) and rear wall (14). A filling opening (19) is formed on the upper side between front wall (13) and rear wall (14). Formed underneath the same is a further opening, specifically a removal opening (20) defined by a perforation line (23). Positioned in the region of the same is a closure means which can be used repeatedly, specifically a ziplock.

The invention relates to a pouch made of film or the like for bulk goods or fibrous material, in particular for a portion of tobacco as pack content, comprising front wall and rear wall, which bound an (upper) opening and are connected to each other laterally and in the region of a base or base edge (12) opposite the opening before the pack content is put in. Furthermore, the invention relates to methods and apparatus for producing pouch packs.

Recently, tobacco pouches of the aforementioned design have become known in which the pouch opening is provided with a ziplock, as it is known. This normally consists of two profiled pieces, which extend on the inner side of front wall and rear wall in the region of the pouch opening and, in the closed position, interengage with projections and depressions.

The invention is based on the object of improving pouch packs, in particular tobacco pouches, with regard to their configuration and in relation to the production, in such a way that improved handling and problem-free fabrication are provided.

In order to achieve this object, the pouch according to the invention is characterized by means of at least two independent openings arranged adjacent to each other, of which one serves as a (filling) opening for the pouch content to be put in and the other (removal) opening serves for the removal of the pouch content.

The finding of the invention consists in that the filling of the pouch and the removal of the pouch content in each case must be carried out via separate openings which are separated from each other but immediately adjacent, so that each opening can be matched to the allocated task with respect to its configuration. According to the invention, the filling opening is closed permanently after the pouch content has been put in, in particular by means of a closure seam. The removal opening is provided with a closure means which acts repeatedly, in particular with a ziplock. In particular, the pouch is configured in such a way that the closure seam is positioned at the free, upper edge of the front wall and the removal opening with ziplock is positioned between closure seam and pouch content. Between the ziplock and closure seam, the pouch, specifically the front wall, has a material weakening, in particular a perforation line, which, when the pouch is first put into use, is opened in order to create the removal opening in this way.

During the production of the pouch, the procedure according to the invention is such that the closure means (ziplock) which acts repeatedly is connected to a continuous material web or film web in the region of an inner side of the front wall, seams directed transversely, specifically lateral seams of the pouch, are then made and after that the pouch is divided off from the material web. The pouch content is introduced via the filling opening, the latter is closed by means of the closure seam, in particular with the simultaneous connection of the ziplock to the rear wall of the pouch.

The apparatus according to the invention has at least two sealing stations. A first sealing unit comprises continuously operating, in particular rotating, sealing elements or sealing rolls for fixing profiled pieces of the ziplock to the continuous material web. The second sealing unit, preferably operating in synchronism, applies the closure seam to the pouches and produces the connection of the ziplock to the rear wall.

Exemplary embodiments of the pouch according to the invention and of the method and apparatus will be explained in more detail below using the drawings, in which:

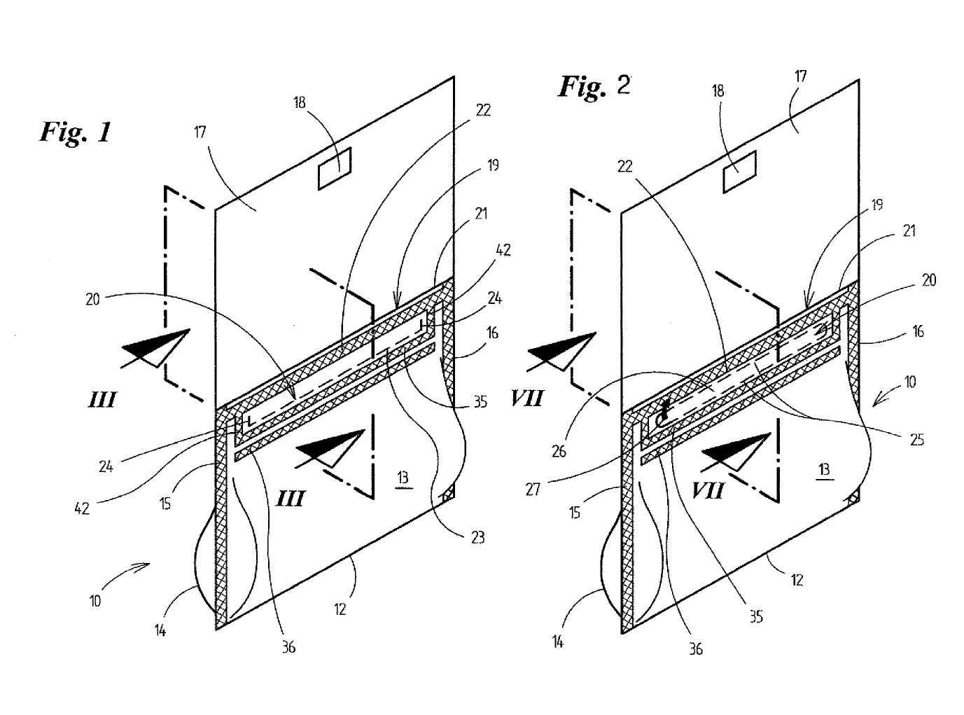

FIG. 1 shows a closed (tobacco) pouch in a perspective illustration,

FIG. 2 shows another design of a pouch, likewise in a perspective illustration,

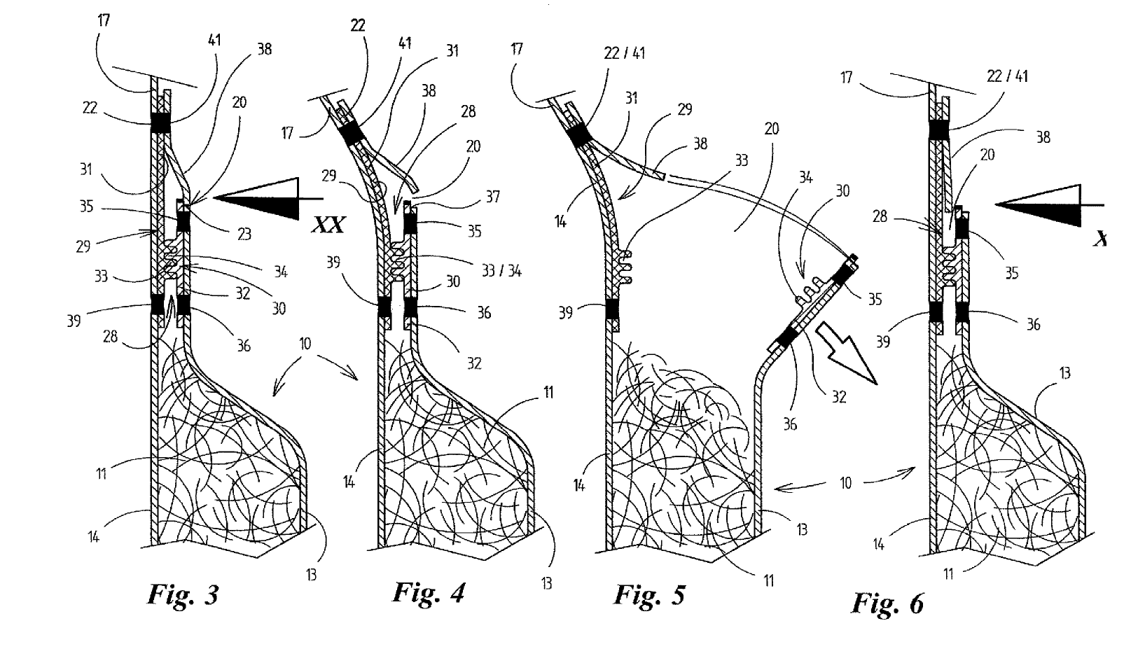

FIG. 3 shows a closure region of the pouch according to FIG. 1 in a vertical section III-III, in an enlarged illustration,

FIG. 4 shows the detail according to FIG. 3 following the opening of a weakening line in order to form the removal opening,

FIG. 5 shows the detail according to FIG. 3, FIG. 4 with the ziplock open,

FIG. 6 shows the detail according to FIG. 3 to FIG. 5 with the ziplock closed again,

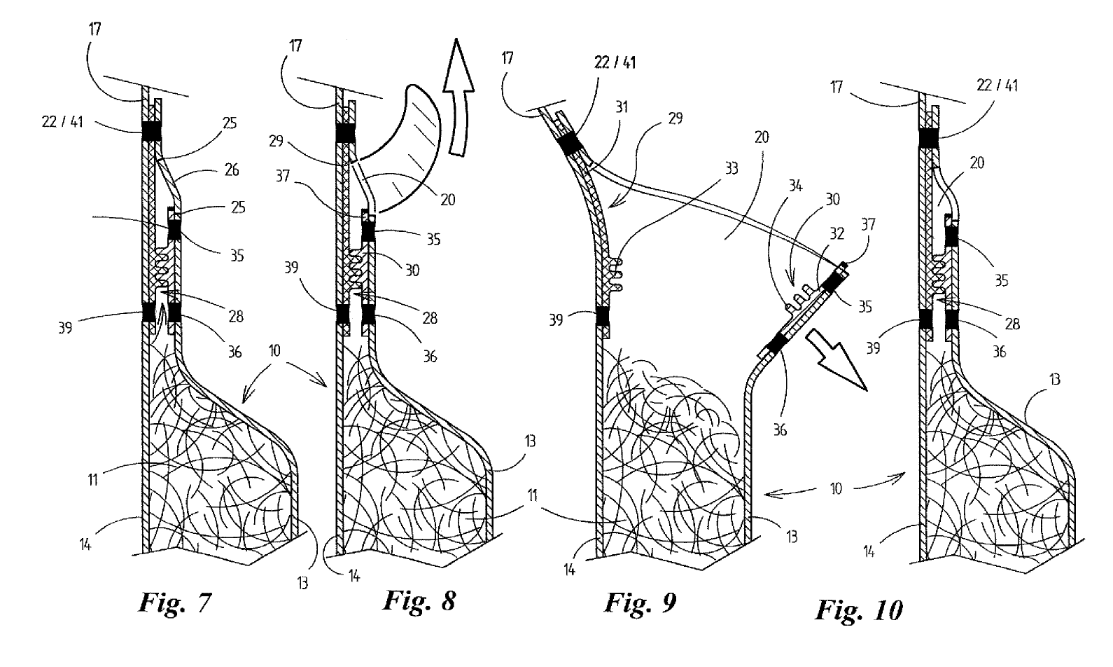

FIG. 7 to

FIG. 10 show illustrations analogous to FIG. 3 to FIG. 6 of the exemplary embodiment according to FIG. 2,

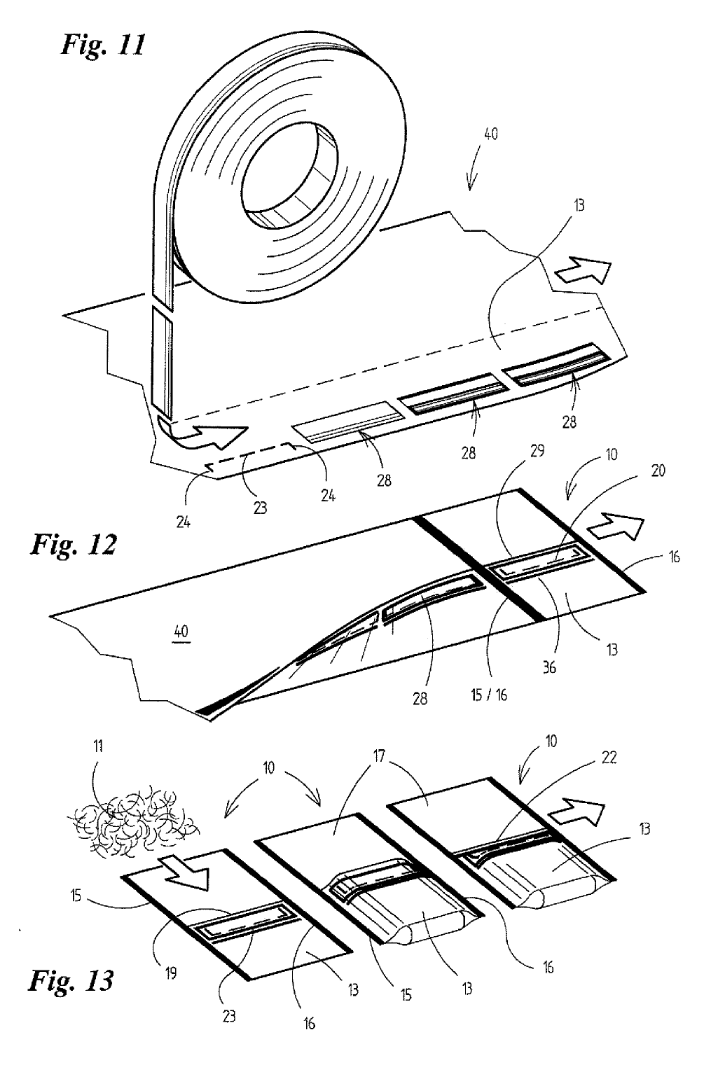

FIG. 11 shows an instantaneous recording during the fabrication of pouches, namely the application of ziplock parts to a material web, in a perspective illustration,

FIG. 12 shows a following phase of the fabrication, namely the formation of pouches from a material web, likewise perspectively,

FIG. 13 shows the filling of pouches and their closure, likewise in perspective illustration,

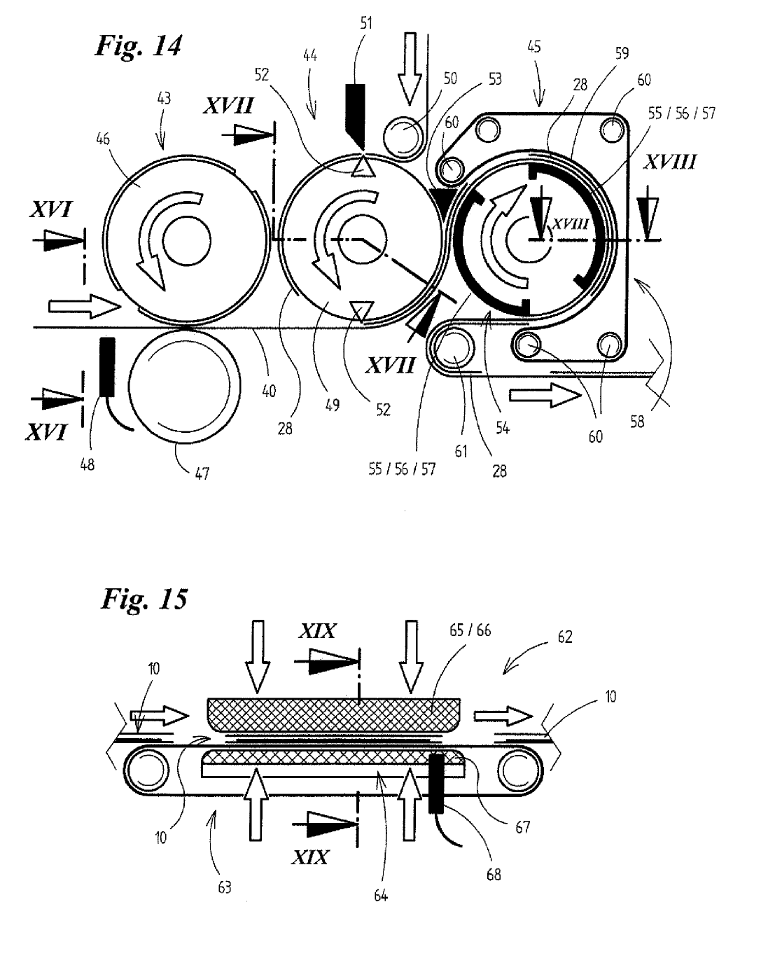

FIG. 14 shows a detail of an apparatus for producing and filling pouches, namely a processing unit having a (first) sealing unit, in a schematic side view,

FIG. 15 shows a (second) sealing unit for processing pouches in side view,

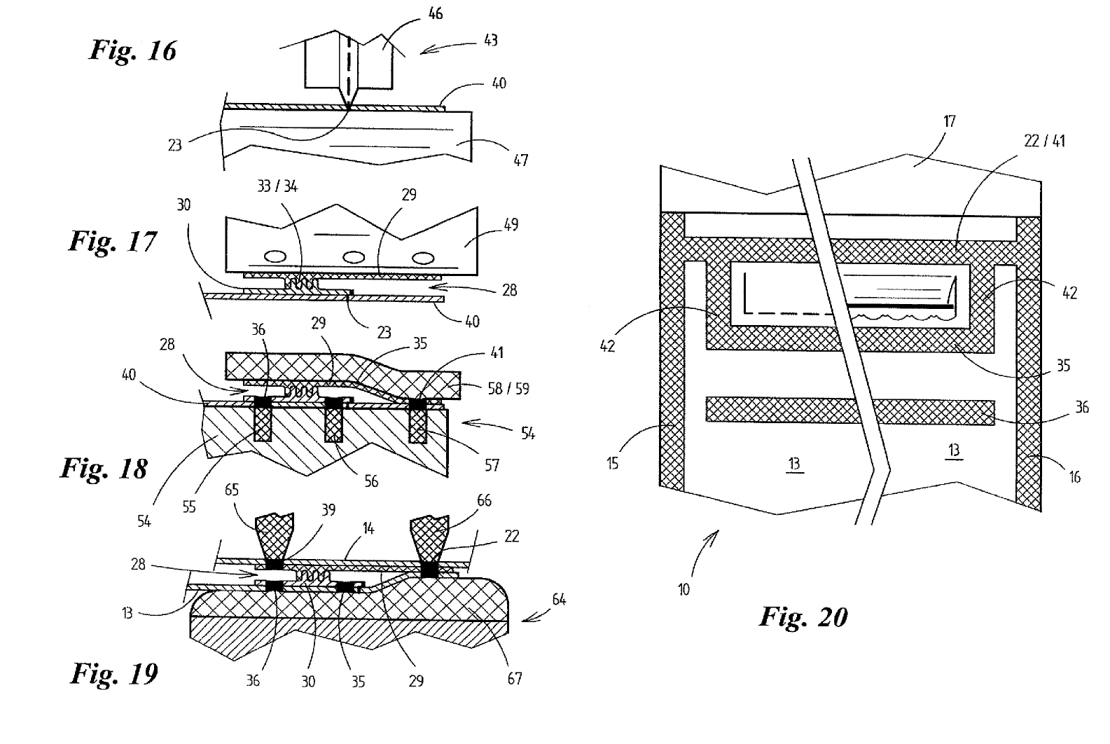

FIG. 16 shows a detail of the unit according to FIG. 14, namely a transverse view and a vertical section in the plane XVI-XVI of FIG. 14,

FIG. 17 shows a transverse or radial section XVII-XVII relating to FIG. 14,

FIG. 18 shows a transverse or radial section XVIII-XVIII in the region of the sealing unit of FIG. 14,

FIG. 19 shows a vertical section XIX-XIX from FIG. 15,

FIG. 20 shows a view of a pouch corresponding to arrow XX in FIG. 3.

The exemplary embodiments illustrated relate to the formation and fabrication of tobacco pouches 10 for a portion of tobacco 11 as pouch content. The pouch 10 consists of a packaging material, in particular thermally sealable film. A blank for forming a pouch 10 is folded, forming a bottom edge 12, so that a front wall 13 and a rear wall 14 rest on each other and form the pouch 10 for holding the portion of tobacco 11. In the region of lateral edges, front wall 13 and rear wall 14 are connected permanently to each other, specifically by means of (upright) lateral seams 15, 16. Alternatively, in each case a folded side wall can be fitted in this region. The rear wall 14 of the pouch 10 is provided with an extension or continuation in order to form a fold-over flap 17 which, when the pouch 10 is closed, is turned over against the front wall 13 and connected detachably to the latter, for example by means of an adhesive label 18.

The pouch 10 has two openings which can be handled independently of each other, namely a filling opening 19 and a removal opening 20. The filling opening 19 serves (only) for the insertion of the pouch content, that is to say the portion of tobacco 11, into the pouch 10. After that, the filling opening 19 is closed permanently. The removal opening 20 is opened when the pouch 10 is first put into use.

The filling opening 19 extends transversely with respect to the pouch 10 and is bounded by front wall 13 and rear wall 14. In the examples, the filling opening 19 is located at an upper transverse edge 21 of the front wall 13. The filling opening 19 extends over the approximately full width of the pouch 10, namely between the two lateral seams 15, 16. After the portion of tobacco 11 has been put into the pouch, the filling opening 19 is closed permanently, specifically by means of a closure seam 22 which extends over the full width of the pouch 10 or at least between the lateral seams 15, 16—at a short distance from the transverse edge 21. The closure seam 22 is in particular formed by means of thermal sealing of the packaging material.

The removal opening 20 is arranged only in the region of the front wall 13 or rear wall 14, here in the region of the front wall 13, specifically immediately below the closure seam 22. The removal opening 20 comprises, firstly, an aperture in the front wall 13 and, secondly, closure means which act repeatedly, which permit the removal opening 20 to be closed again following removal of partial portions of the pack content.

The actual removal opening 20 is formed by weakening lines in the film of the front wall 13. In the exemplary embodiment of FIG. 1, a transversely oriented perforation line 23 is provided. This ends at a distance from the lateral edges or lateral seams 15, 16 of the pouch 10, so that the removal opening 20 has a shorter longitudinal extent than the filling opening 19. The single perforation line 23 is provided at the ends with a transversely oriented perforation limb 24 in each case. As a result, an opening flap or an enlarged removal opening 20 is produced.

In the exemplary embodiment of FIG. 2, a closed perforation line 25 is provided having two parallel sections connected to each other. These define a closure strip 26 that can be divided out from the film material. At one end, the closure strip 26 is provided with a grip tab 27 by means of U-shaped perforation.

In the region of the removal opening 20, a ziplock 28 is positioned as a closure means that acts repeatedly. The ziplock consists of two profiled strips 29, 30, which can be pulled apart and connected to each other by pressure. Each profiled strip 29, 30 has a carrier strip 31, 32 and connecting profiles 33, 34 fitted to the latter. The profiled strips 29, 30 consist of a thermally sealable material and are connected to front wall 13 and rear wall 14 by sealing, specifically in such a way that the connecting profiles 33, 34 are located underneath the removal opening 20. In the closed position, the rib-like connecting profiles 33, 34 enter into each other alternately with a form fit and in this way form a connection which is effective but easy to open over the full extent of the removal opening 20.

The construction of the pouch 10 in the region of the removal opening 20 is formed in a particular way. The profiled strip 30 facing the inner side of the front wall 13 is fixed to the front wall 13 in an upper edge region by two parallel connecting seams 35, 36. The carrier strip 32 is positioned in such a way that an overlap 37 with respect to the perforation line 25 or a lower edge of the removal opening 20 is created. The overlap 37 is marked in color and, after the pouch 10 has been opened for the first time, fixes a film strip 38 produced above the perforation line 25 in the closed position (FIG. 6). The connecting seams 35, 36 are arranged above and below the connecting profiles 33, 34.

The associated profiled strip 29 has a carrier strip 31 with a greater width. The latter is fixed to the inner side of the rear wall 14 by means of a connecting seam 39 below the connecting profile 33 and, above the connecting profile 33, is gripped by the closure seam 22, which accordingly connects three material layers to one another. The lower connecting seams 36 and 39 are located at the same height.

When the pouch 10 is first put into use, the perforation line 25 is severed by hand or the closure strip 26 is divided out of the front wall 13. After that, by gripping the free tab of the pouch projecting beyond the ziplock 28, the ziplock 28 is pulled apart (FIG. 5). Tobacco can then be removed. After that, the connecting profiles 33, 34 are pressed onto each other by hand again, so that a closed position corresponding to FIG. 6 to FIG. 10 results.

One special feature is the production and filling of the pouches. First of all, the weakening lines for the removal opening 20, namely the perforation line 23 or 25, including perforation limb 24, are applied to a continuous material web 40 or film web, adjacent to a free lateral edge. After that, the ziplock 28 is laid on in the region of these perforations. The mutually associated profiled strips 29, 30 are applied to the material web 40, specifically to the side forming the inner side of the front wall 13 and pointing upward. The ziplock 28 consisting of the two profiled strips 29, 30 is applied in sections corresponding to the dimension of a pouch 10. The relative position is chosen such that the profiled strip 30 is oriented downward.

The sections of the ziplock 28 laid on the material web 40 are connected to the material web 40 by making sealing seams. In a first continuous sealing process, the connecting seams 35 and 36 for connecting a profiled strip 30 on the front side to the front wall 13 are made. Furthermore, a preliminary seam 41 is produced, by means of which an upper part or limb of the profiled strip 29 on the inner side is connected to the inner side of the front wall 13. This preliminary seam 41 extends in the region of the closure seam 22 to be made later. In this first sealing process, accordingly, the ziplock 28 is connected only to the front wall 13 by three parallel sealing seams 35, 36, 41. At the same time, transverse seams 42 are fitted (FIG. 20) which connect the ends of the (upper) connecting seam 35 to the transverse seam 42. As a result, the removal opening 20 is surrounded on all sides by stabilizing sealing seams.

An edge strip of the material web 40 is then folded over continuously (FIG. 12) in order to form the regions of the front wall 13. The lateral seams 15, 16 are then made on the material web 40 as a double seam by means of transverse sealing, and the pouch 10 is divided off from the material web 40 (FIG. 13).

The individual pouches 10 are then transported onward at a distance from one another, the portion of tobacco 11 being introduced into the pouch 10 via the free filling opening 19 transversely with respect to the conveying direction. The closure means, specifically the ziplock 28, is in this case covered against the tobacco by the carrier strip 31, so that no tobacco can get into this region, also because of the action of the preliminary seam 41. The sealing seams 36 and 39 located inside the pouch are arranged at the edge or a short distance from the edge of the profiled strips 30, 31, so that during filling and in particular during the use of the pouch, tobacco content cannot get in between profiled strips of the ziplock and walls of the pouch.

After the portion of tobacco 11 has been put in, the closure seam 22 is produced in the region of the transverse seam 42. Furthermore, the connecting seam 39 for fixing the profiled strip 29 to the inner side of the rear wall 14 is made underneath the connecting profile 33. The pouch 10 is therefore ready for use.

A special feature is units or assemblies of an apparatus. A first apparatus unit according to FIG. 14 is provided with a perforation assembly 43 for applying the perforation line 23 or 25, a following transfer element 44 for applying the ziplock sections to the material web 40, and a sealing assembly 45 for making a plurality of connecting seams during the transport of the material web 40. The perforation assembly 43 comprises a perforation roll 46 above the horizontally extending material web 40 and a backing roll 47 underneath the material web 40. A circumferential surface of the perforation roll 46 has cutting or perforating knives which, as a result of rotation of the perforation roll 46, transfer weakening lines or perforation lines to the appropriately transported material web. The exact relative position of the material web 40 is monitored by a sensor 48.

The transfer element 44 following immediately in the conveying direction comprises a suction roll 49. A continuous strip of ziplock 28 is supplied to the latter on the upper side and is laid on the circumference of the suction roll 49 by means of deflection roll 50. Positioned on the upper side of the suction roll 49 is a dividing assembly, specifically a stationary dividing knife 51, which interacts with in each case one of two diametrically opposite opposing knives 52 on the suction roll 49. The ziplock section divided off from the continuous strip is conveyed onward by the suction roll 49 at a slightly higher circumferential speed, so that the necessary distances between the sections of the ziplock 28 are created on the suction roll 49. The ziplock sections are transferred onto the material web 40 by the suction roll 49. A wedge-shaped deflection element 53 has the effect that the unit comprising material web 40 and ziplock section is lifted off the circumference of the suction roll 49 and is transferred to the circumferential surface of an immediately following sealing roll 54.

The sealing roll 54 is part of the sealing assembly 45. The sealing roll 54 has sealing jaws or sealing strips 55, 56, 57 which extend in the circumferential direction and are therefore curved. These sealing strips 55, 56, 57 are lands which are formed in the manner of segments and can be heated, which extend parallel to one another in the circumferential direction of the sealing roll 54 and produce the necessary sealing temperature at the surface, specifically at the contact surface of the material web 40. In the circumferential direction, the length of these sealing strips 55, 56, 57 corresponds to the length of the sealing seam 35, 36, 41 to be produced in each case. The dimensions are chosen overall such that, for each revolution of the rolls 46, 49, 54, two pouches 10 are prepared, specifically provided with perforations and ziplock sections. Accordingly, the sealing roll 54 has two groups of sealing strips 55, 56, 57 arranged at a distance from each other in the circumferential direction.

The sealing roll 54 is provided with an external guide which, during the contact with the material web 40, produces a certain contact pressure on the circumference of the sealing roll 54 in order to ensure the action of the sealing strips 55, 56, 57. The external guide comprises a conveyor band or belt 58 which, beginning in the region of the deflection element 53, bears with a guide run 59 on the circumference of the sealing roll 54 and on the material web 40. A plurality of deflection rolls 60 effect the form-fitting contact of the belt 58 or the guide run 59.

The material web 40 provided with the sections of the ziplock 28 is transported onward in a horizontal direction over a deflection roll 61 after leaving the circumference of the sealing roll 54, the ziplock 28 remaining on the upper side in each case. By means of a known guide element, the edge strip is then deflected over in order to form the front wall 13. Likewise in a known manner, the (double-width) transverse seams for forming the lateral seams 15, 16 are made, and the pouches 10 are divided off from the material web 40.

Following the filling of the pouches 10, these come into the region of a sealing unit 62 according to FIG. 15. In the region of the latter, the pouch is completed as regards the sealing. Firstly, the closure seam 22 is made, specifically in the region of the preliminary seam 41. Secondly, the rear profiled strip 29 with the ziplock 28 is fixed to the rear wall 14 by the connecting seam 39 formed underneath the connecting profiles 33, 34.

The pouches 10 supplied in the transverse position are transferred to an intermediate conveyor 63, which transports the pouches cyclically one after another through the sealing unit 62. The pouch 10 processed in each case rests on an upper run of the intermediate conveyor 63, namely between a lower support 64 and upper sealing elements which can be moved up and down, namely strip-like sealing pieces 65, 66. The support 64 consists of resilient material or has a resilient upper layer 67 of rubber or the like. This adapts to the different thickness and positional formation of the pouch 10 in this region (FIG. 19). Accordingly, in the region of the sealing unit 62, the pouch 10 is oriented with the rear wall 14 upward and faces the sealing elements 65, 66 for the final sealing.

The exact position of the pouch 10 in the sealing unit 62 is monitored and controlled by a sensor 68.

### LIST OF DESIGNATIONS

10 Pouch
11 Portion of tobacco
12 Bottom edge
13 Front wall
14 Rear wall
15 Lateral seam
16 Lateral seam
17 Fold-over flap
18 Adhesive label
19 Filling opening
20 Removal opening
21 Transverse edge
22 Closure seam
23 Perforation line
24 Perforation limb
25 Perforation line
26 Closure strip
27 Grip tab
28 Ziplock
29 Profiled strip
30 Profiled strip
31 Carrier strip
32 Carrier strip
33 Connecting profile
34 Connecting profile
35 Connecting seam
36 Connecting seam
37 Overlap
38 Film strip
39 Connecting seam
40 Material web
41 Preliminary seam
42 Transverse seam
43 Perforation assembly
44 Transfer element
45 Sealing assembly
46 Perforation roll
47 Backing roll
48 Sensor
49 Suction roll
50 Deflection roll
51 Dividing knife
52 Opposing knife
53 Deflection element
54 Sealing roll
55 Sealing strip
56 Sealing strip
57 Sealing strip
58 Belt
59 Guide run
60 Deflection roll
61 Deflection roll
62 Sealing unit
63 Intermediate conveyor
64 Support
65 Sealing piece
66 Sealing piece
67 Upper layer
68 Sensor

1. A pouch made of film or the like for bulk goods or fibrous material, in particular for a portion of tobacco (11) as pack content, comprising front wall (13) and rear wall (14), which bound an (upper) opening and are connected to each other laterally and in the region of a base or base edge (12) opposite the opening before the pack content is put in, characterized by at least two independent openings arranged adjacent to each other, of which a filling opening (19) serves (only) for the pouch content to be put in and the other opening, namely removal opening (20, serves (only) for the removal of the pouch content.

2. The pouch as claimed in claim 1, characterized in that the filling opening (19) is closed (permanently) after the pouch content has been put in, in particular by means of thermal sealing or by means of adhesion, and in that the removal opening (20) has a closure means which acts repeatedly, in particular a ziplock (28).

3. The pouch as claimed in claim 1, characterized by the following features:
a) the filling opening (19) is formed in the region of a free transverse edge (21) of the front wall (13), on the one hand, and the rear wall (14), on the other hand, or a fold-over flap (17) of the rear wall (14),
b) the removal opening (20) is formed in the front wall (13) immediately underneath the filling opening (19) or a closure seam (22) of the filling opening (19).

4. The pouch as claimed in claim 1, characterized in that the closure means that act repeatedly, in particular the ziplock (28), is fitted on the inner side between front wall (13) and rear wall (14) and is connected to the front wall (13) on one side and to the rear wall (14) on the other side.

5. The pouch as claimed in claim 1, characterized in that, in order to form the removal opening (20), the front wall (13) above the ziplock (28) or above closable connecting profiles (33, 34) of the ziplock (28) has an elongated weakening line, in particular a perforation line (23) or a double perforation line (25), in order to bound a closure strip (26) that can be divided out of the front wall (13).

6. The pouch as claimed in claim 1, characterized in that a profiled strip (30) on the front side of the ziplock (28) is connected to the front wall (13) underneath the removal opening (20), in particular by a connecting seam (35, 36) in each case above and below the connecting profile (34).

7. The pouch as claimed in claim 1, characterized in that the profiled strip (29) on the rear side underneath the connecting profile (33) is connected to the rear wall (14) by a connecting seam (39) and above the connecting profile (33), in the region of the closure seam (22), to the rear wall (14) and the front wall (13).

8. The pouch as claimed in claim 1, characterized in that the profiled strip (29) on the rear side of the ziplock (28) is connected to the inner side of the front wall (13) by means of a preliminary seam (41) above the profiled strip (29) before the fitting of the closure seam (22) and before the pouch content is put in, the preliminary seam (41) preferably extending in the region of the closure seam (22).

9. A method for producing pouches (10) comprising front wall (13) and rear wall (14) and, if appropriate, a fold-over flap (17) connected to the rear wall (14), in order to hold portions of tobacco (11) as pouch content, the pouches (10) being produced from a continuous film web or material web (40) by forming the front wall (13) by folding over an edge strip of the material web (40) by means of transversely oriented dividing cuts, with the simultaneous production of lateral seams (15, 16) for connecting front wall (13) and rear wall (14), characterized by the following features:
a) at an edge of the material web (40) facing the front wall (13) to be produced, during the transport of the material web (40), weakening lines running successively in the longitudinal direction of the material web (40), in particular perforation lines (23, 25), are made in the material web (40),
b) then, in the region of the weakening lines, sections of closure means that act repeatedly are applied to the upwardly oriented inner side in the region of the front wall (13) to be produced, specifically in particular sections of a ziplock (28) consisting of profiled strips (29, 30),
c) the sections of the ziplock (28) are then connected to the material web (40), in particular by means of thermal sealing, covering the perforation line (23, 25),
d) the edge strip of the material web (40) is then folded over in order to form the front walls (13) of the pouch (10),
e) after that, the transversely oriented lateral seams (15, 16) are made outside the sections of the ziplock (28), and the pouches (10) are produced by means of a transversely oriented dividing cut,
f) the portion of tobacco (11) is then introduced into the pouch (10),
g) finally, the closure seam (22) is made in the region of the filling opening (19) and the ziplock (28) is connected to the rear wall (14).

10. The method as claimed in claim 9, characterized in that the closed ziplock (28) is connected to the material web (40) in the region of the inner side of the front wall (13) in a first sealing step, to be specific, the profiled strip (30) on the front side by means of two connecting seams (35, 36), and the profiled strip (29) on the rear side by means of a preliminary seam (41) above the connecting seam (35) and above the profiled strip (30).

11. The method as claimed in claim 9, characterized in that the profiled strip (29) on the rear side of the ziplock (28) is connected to the rear wall underneath the connecting profile (33) in a further sealing step, in particular by means of a connecting seam (39), after a portion of tobacco (11) has been put in.

12. The method as claimed in claim 11, characterized in that the closure seam (22) and the connecting seam (39) are made on the pouch (10) in an instantaneous rest position of the latter.

13. An apparatus for producing pouches (10) from thin packaging material, in particular from sealable film, which can be supplied as a material web (40), sections of a ziplock (28) being positioned at an edge of the material web (40) at a distance from one another and being connected to the material web (40) by means of thermal sealing, characterized in that the material web (40) with the sections of the ziplock (28) can preferably be led continuously through a (first) sealing station having a sealing assembly (45), which has a rotating sealing roll (54) having sealing strips (55, 56, 57) fitted to the circumference and which, as a result of the wrap of the sealing roll (54) during a phase of the transport of the material web (40), bear on the latter in order to form sealing seams, specifically connecting seams (35, 36) and a preliminary seam (41).

14. The apparatus as claimed in claim 13, characterized in that the sealing roll (54) is assigned a sealing element on the circumference in order to press the material web (40) together with ziplock (28) onto the circumference of the sealing roll (54), in particular a belt (58) having a guide run (59) surrounding the sealing roll (54) in a subregion.

15. The apparatus as claimed in claim 13, characterized in that the sealing roll (54) has two groups of parallel sealing strips (55, 56, 57) which extend along the circumference and which are assigned to the connecting seams (35, 36) and to the preliminary seam (41) in order to seal two pouches (10) during one revolution of the sealing roll (54).

16. The apparatus as claimed in claim 13, characterized in that a transfer element (44) with suction roll (49) is arranged upstream of the sealing assembly (45) in order to transfer sections of the ziplock (28) onto the material web (40) at predefined intervals.

17. The apparatus as claimed in claim 13, characterized in that a perforation assembly (43) is arranged upstream of the sealing assembly (45) and, if appropriate, the transfer element (44) in order to transfer perforation lines (23, 25) onto the material web (40) in order to form removal openings (20) in the finished pouch (10).

18. The apparatus as claimed in claim 13, characterized by a (further) sealing unit (62) for making the closure seam (22) on the individual pouches (10) filled with portions of tobacco (11) in an instantaneous rest position of the pouches (10).

19. The apparatus as claimed in claim 18, characterized in that the sealing unit (62) has sealing pieces (65, 66) that can be moved up and down above the pouches (10), in particular two sealing pieces for producing two sealing seams, and in that the pouch (10) rests on a support (64) with a resilient upper layer (67).
